(19) United States
(12) Patent Application Publication
(10) Pub. No.: US 2026/0076358 A1
(43) Pub. Date: Mar. 19, 2026

(54) Treestand Platform extension

(71) Applicant: Andrae D'Acquisto, Bellevue, IA (US)

(72) Inventor: Andrae D'Acquisto, Bellevue, IA (US)

(21) Appl. No.: 18/831,812

(22) Filed: Sep. 13, 2025

Related U.S. Application Data
(60) Provisional application No. 63/732,748, filed on Sep. 19, 2024.

(51) Int. Cl. A01M 31/02

(52) U.S. Cl. CPC A01M 31/02

(57) ABSTRACT

The present invention relates generally to a platform extension that can be attached to tree stand platforms to provide the user with a larger platform surface. The extension of the invention can also be used to extend or enlarge treestand seats.

### FIELD OF THE INVENTION

The present invention relates generally to a platform extension that can be attached to tree stand platforms to provide the user with a larger platform surface. The extension of the invention can also be used to extend or enlarge treestand seats.

### BACKGROUND OF THE INVENTION

Portable treestands for hunting have been used for many years. Such treestands are available in an extremely wide variety of types, providing a myriad of sizes, shapes, materials of construction, mounting mechanisms and other features. Treestands come in four main varieties: tripod stands, ladder stands, hang-on stands, and climbing treestands. Tripod stands do not require a tree in order to be erected and utilize an elevated tripod. Ladder stands utilize a ladder with a platform attached to top end thereof. They are leaned against a tree and secured with a straps and chains. Hang-on stands are platforms that are strapped to a tree and utilize separate climbing utensils such as climbing sticks. Finally, climbing treestands come in two separate sections that are configured to allow the hunter to shimmy up a tree using the treestand itself as a climbing aid.

Since hunters spend many hours in a treestand, comfort is of extreme importance. In this regard, hunters/users sometimes find that the platform and/or seat of the treestand to be smaller than desired for optimum comfort during use. Prior to the invention, the only alternative was to purchase a treestand with a larger platform and/or seat, which is an expensive proposition. Accordingly, it is desirable to provide a built-on structure to allow for the expansion or enlargement of a treestand platform and/or seat without the need to purchase a larger treestand. The present invention provides an attractive alternative to purchasing a treestand with a larger platform i.e., the extension of the invention allows one to enlarge the platform and/or seat of the users current treestand.

It is therefore an object of the invention to provide the hunter to enhance the comfort of a tree stand by providing a platform extension structure that allows the hunter to enlarge the tree stand platform and/or seat of said treestand.

### SUMMARY OF THE INVENTION.

The present invention relates generally to a platform extension that can be attached to treestand platforms to provide the user with a larger platform surface area to stand on for greater safety and comfort. The extension of the invention can also be used to extend or enlarge treestand seat platforms. The treestand platform extension described herein solves the problems of the prior art by providing a platform extension assembly which enables one to enlarge the surface area of a treestand the platform to enhance treestand safety and comfort. The platform extension of the invention can be configured to accommodate a variety of treestand platforms that lack the desired surface area including hang-on treestands, ladder stands, climbing treestands and tripod stands.

The platform extension of the invention is configured to utilize a variety of mounting hardware for mounting to a variety of treestand platforms and seats. Mounting hardware includes but is not limited to bolts with or without locking nuts that affix the platform extension to the end of the platform and/or seat.

### BRIEF DESCRIPTION OF THE DRAWINGS

These and other features, aspects, and advantages of the treestand will become better understood with reference to the following description, appended claims, and accompanying drawings where:

FIG. 1 shows a typical prior art hang on treestand.

FIG. 2 shows a trapezoidal shaped treestand platform.

FIG. 3 shows the top view of the platform extension of the present invention.

FIG. 4 shows the platform extension of the invention coupled to an exemplary treestand platform.

### DETAILED DESCRIPTION OF THE INVENTION

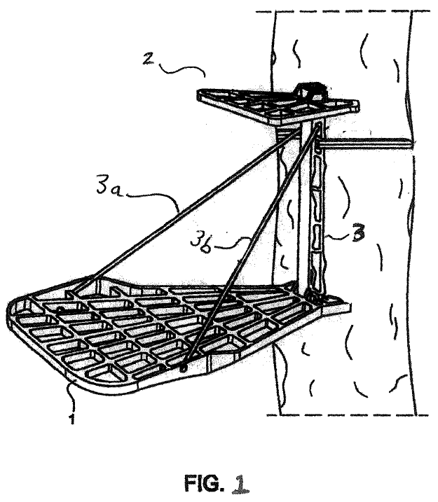

FIG. 1 illustrates a typical hang-on treestand comprising a platform 1, a seat 2 a center support structure 3 and supporting cables 3a, 3b. The platform extension of the invention is not limited to use with hang-on treestands and can be configured for use with any treestand type.

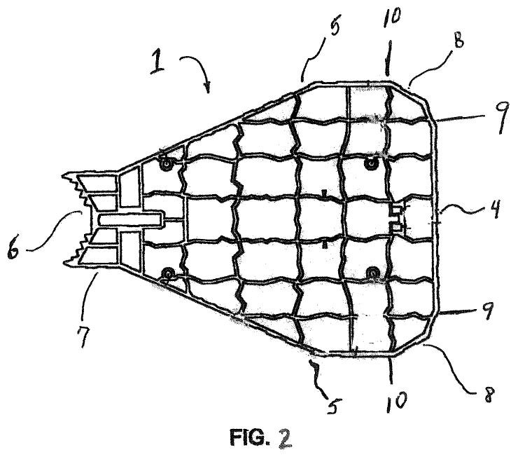

Treestand platforms and treestand seats can be of various shapes including square, rectangular, trapezoidal, rounded, oval, etc., i.e., the shape of the platform is not limiting. For ease of illustration, applicant refers to FIG. 2 which is directed to a trapezoidal shaped treestand platform. The outer edge of the platform 4, i.e., the edge opposite the tree to which the treestand is mounted, defines the base from the ends of which two convergent side edges 5 extend generally radially towards the tree to integral connections with the edges of a V-shaped notch 6 on the inner edge 7 of the platform 1. Rounded corners 8 preferably define transition zones between the outer edge 4 and the side edges 5 of the platform 1. However, these transition zones are not limited to rounded corners and can be of various shapes or angles, i.e., for example the transition zones may be squared off.

With all treestand platforms the outer face 4, i.e., the side of the platform opposite the tree facing side transitions into the convergent side edges 5 through transition zones 8 that can be rounded, angled, squared off, etc., hereinafter referred to as the curvature of the transition zone. The point of curvature 9 defines the beginning of the curvature of the transition zone 8 of the treestand platform, while the point of tangency 10 defines the end of the curvature of the transition zone.

With treestand platforms that have transition zones defined by one or more angles, the point at which the outer edge 4 of the platform meets the convergent side edges 5 of the platform extension is defined as the transition zone.

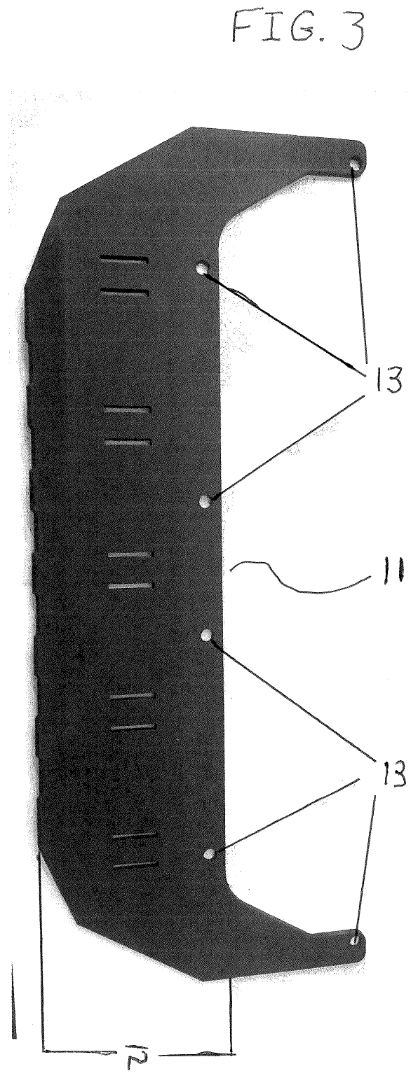

FIG. 3 illustrates the platform extension 11 of the invention detached from a treestand platform 1 to be enlarged. The platform extension 11 is characterized by several geometric configurations that avoid failure at the attachment points to the main platform. In one embodiment, the platform extension of the invention is attached to the platform by means of a lap joint, i.e., a joint that involves overlapping two edges of the materials and joining them together using various fastening methods, such as bolts, rivets, etc. The term lap joint is intended to encompass both a plain lap joint where two edges offset simply by their thickness and some length along the edge, and a flush lap joint that involves offsetting one edge to slide under the other piece of material, with the face of each material being on the same plain. Either lap joint can be employed in the context of the invention. However, straight line lap joints can be susceptible to failure under heavy load along the fold line, i.e., the line where the platform edge runs along the bottom of the platform extension. This edge line defines a necking line, i.e., a mode of tensile deformation where relatively large amounts of strain localizes disproportionately in a small region of material along the fold line. The platform extension 11 of the invention minimizes the risk of potential failure by avoiding use of a straight-line lap joint. As one of ordinary skill will appreciate, there are several methods for attaching the platform extension of the invention to a treestand platform and/or seat and the invention is not limited to any particular method of attachment provided that risk of failure as described above is mitigated.

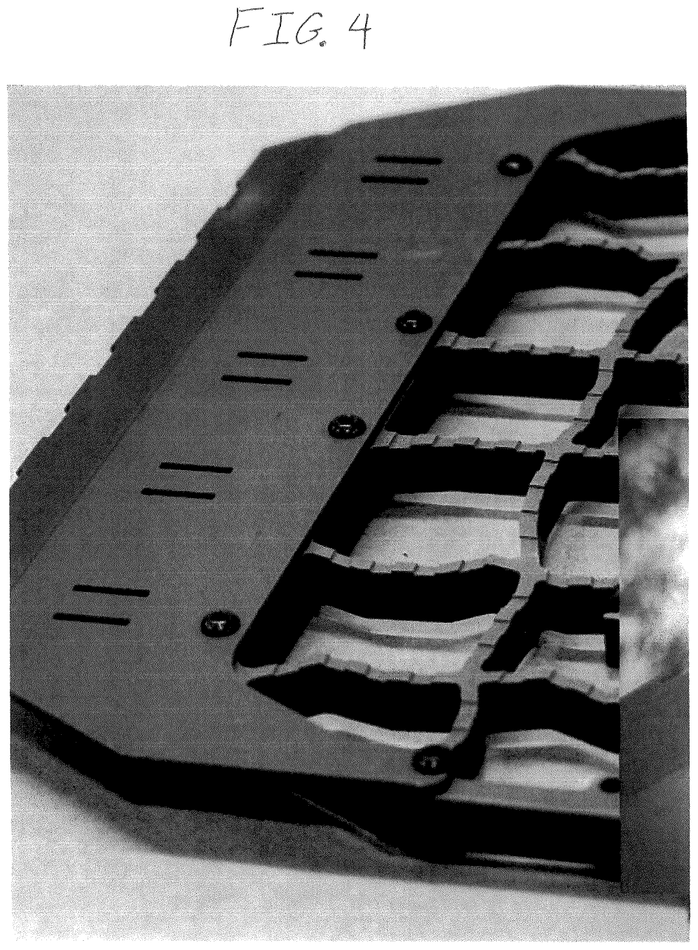

Referring to FIGS. 3 and 4 the platform extension of the invention minimizes risk of failure by extending around the point of curvature 9, i.e., the beginning of the curvature of the transition zone of the treestand platform, until just before the point of tangency 10, i.e., the end of the curvature of the transition zone, where the penultimate attachment hole is located. In another embodiment the platform extension 11 of the invention extends around the point of curvature 9 to the point of tangency 10. In another embodiment the platform extension 11 of the invention extends around the point of curvature 9 to a point beyond the point of tangency 10. In yet another embodiment, the platform extension of the invention extends around the point of curvature 9 to a point that is 1-4 inches, in another embodiment 1-3 inches, and in another embodiment 1-2 inches beyond the point of tangency 10. In still another embodiment the extension extends beyond the point of tangency up to the point where the support cables 3a, 3b are affixed to the treestand platform 1. By extending the platform extension around the corners of the platform to the point of tangency 10 and beyond, the load on the necking line of straight-line lap joint, is spread around the curvature of the transition zone thereby minimizing the strain along the necking line which increases strength and greatly reduces the risk of failure under load.

With treestand platforms that have convergent zones defined by one or more angles, the point at which the outer edge 4 of the platform meets the convergent side edges 5 of the platform extension is defined as the transition zone. In this embodiment, the platform extension 11 of the invention extends around the point at which the outer edge 4 of the platform meets the convergent side edges 5 of the platform 11 up to the point at which the support cables 3a, 3b are affixed to the platform. In another embodiment the platform extension 11 of the invention extends a distance of from 1 to 4 inches, in another embodiment 1-3 inches, and in another embodiment 1-2 inches beyond the point at which the outer edge 4 of the platform meets the convergent side edges 5 of the platform 11.

This same concept is generally employed in the seat extension of the invention. More specifically, the invention also relates to a seat extension for enlarging the surface area of a treestand seat, said extension comprising a plurality of openings configured to receive a plurality of fixing bolts for attaching said extension to a treestand seat, said seat having a plurality of receiving holes configured to receive said fixing bolts. The seat extension is generally of rectangular cross section approximating the width of the treestand seat to which it is configured to attach. The seat extension can be of any length desired by the user. In one embodiment said extension has a length of up to 6 inches, in another embodiment up to 5 inches, in another embodiment from 1-4 inches and in yet another embodiment 2-4 inches. In another embodiment the extension extends around the outer edge of said seat to a point of up to 6 inches beyond the point of tangency of said seat.

In another embodiment said seat extension has a width up to 6 inches wider than the width of the seat to which it is attached, in another embodiment from 1-4 inches wider than the width of the seat and a length of from 1 to 4 inches, wherein said extension extends 1-4 inches beyond the point of tangency of said seat.

In another embodiment the seat extension has a width of from 2 to 4 inches wider than the width of the seat to which it is attached and a length of from 2 to 4 inches, wherein said extension extends to the point of tangency of said seat.

The platform extension 11 of the invention is generally of rectangular cross section and approximately as wide as or slightly wider than the treestand platform to which it is attached. The length of the extension, while generally not limiting, is preferably from about 1 to 10 inches in length 12 as shown in FIG. 3, and any length in between. In another embodiment the platform extension of the invention is from 1 to about 8 inches in length, in another embodiment from 1 to about 6 inches in length, in another embodiment from about 1 to about 5 inches in length in another embodiment from about 2 to about 5 inches in length. In another embodiment the platform extension is from about 2 to about 4 inches in length, and in yet another embodiment it is 2, 3, 4 or 5 inches in length.

The platform extension 11 of the invention can also is up to 8 inches wider than the platform to which it is attached, i.e., up to 4 inches wider on either side of the treestand platform, thereby also widening the width of the treestand platform. In another embodiment the platform extension 11 of the invention can be to up to 6 inches wider, in another embodiment up to 4 inches wider and in yet another embodiment up to 2 inches wider than the platform to which it is attached. In this fashion, one can conveniently enlarge both the length and the width of the treestand platform.

The platform extension of the invention can also be configured to accommodate a variety of accessories including bow holders, camera filming supports, leg support assemblies, including folding leg supports and the like.

To attach the platform extension of the invention to a treestand platform one need only carefully align the plurality of openings or attachment holes 13 of the extension 11 to receiving or attachment holes in the treestand platform. If necessary, the hunter may have to drill holes through the platform. However, this is often not necessary because many prior art platforms already include holes therethrough already. Once the attachment holes of the platform extension are aligned with the receiving or attachment holes of the platform, the fixing bolts are inserted through the aligned holes and nuts are attached to said bolts and tightened securing the platform extension to the platform.

FIG. 4 shows the extension 11 of the invention attached to a treestand platform 1 by a number of fixing or mounting bolts.

The platform extension 11 of the invention can be fabricated from a variety of materials including steel, stainless, carbon fiber, aluminum and/or aluminum allows. Aluminum platform extensions can be machined, or water jetted from aluminum plate stock, or can be cast from aluminum. When utilizing aluminum to fabricate the platform extensions of the invention the aluminum must be of sufficient strength, which typically requires hardening either before or after fabrication.

The outer edge of said extension 11 can also have a lip that is turned up slightly which will allow the user to locate where the outer edge of the extension is and to prevent the user from slipping off the front of the extension. If the extension of the invention is configured to also widen the treestand platform, the outer edges of the sides of said extension can also have a lip that is turned up slightly which allows the user to clearly feel where the extension ends which enhances safety and prevents the user from slipping off the edge of the extension. These lips can also be turned downwards depending on the needs of the user.

It would be appreciated by those skilled in the art that various changes and modifications can be made to the illustrated embodiments without departing from the spirit of the present invention. All such modifications and changes are intended to be within the scope of the present invention except insofar as limited by the appended claims.

1. A platform extension for enlarging the surface area of a treestand platform, said extension comprising a plurality of openings configured to receive a plurality of fixing bolts for attaching said extension to a treestand platform, said platform having a plurality of receiving holes configured to receive said fixing bolts, said extension generally of rectangular cross section approximating the width of the treestand platform to which it is configured to attach, wherein said extension is from 1 to 10 inches in length and wherein said extension extends around the outer edge of said platform beyond the transition zone up to the point at which supporting cables are attached to said platform.

2. The extension of claim 1 wherein said extension extends beyond the transition zone to a point up to 4 inches beyond the point of tangency of said treestand platform.

3. The extension of claim 1 wherein said extension extends beyond the transition zone to a point up to 3 inches beyond the point of tangency of said treestand platform.

4. The extension of claim 1 wherein said extension extends beyond the transition zone to a point up to 2 inches beyond the point of tangency of said treestand platform.

5. The extension of claim 1 wherein said extension has a length of from 1 to 6 inches.

6. The extension of claim 5 wherein said extension has a length of from 2 to 5 inches.

7. The extension of claim 6 wherein said extension has a length of from 2 to 4 inches.

8. A platform extension assembly for enlarging the surface area of a treestand platform, said extension comprising a plurality of openings configured to receive fixing bolts for attaching said extension to a treestand platform, said platform having a plurality of receiving holes configured to receive said fixing bolts, said extension generally of rectangular cross section having a width of up to 8 inches wider than the treestand platform to which it is configured to attach and a length of from 1 to 6 inches, wherein said extension extends around the outer edge of said platform beyond the transition zone up to the point at which the supporting cables are attached to said platform.

9. The extension of claim 8 wherein said extension has a width that is from 1-6 inches wider than the treestand platform to which it is configured to attach, and a length of from 1 to 5 inches, wherein said extension extends beyond the transition zone to a point of from 2 to 6 inches beyond the point of tangency of said treestand platform.

10. The extension of claim 9 wherein said extension extends beyond the transition zone to a point of from 2 to 4 inches beyond the point of tangency of said treestand platform.

11. The extension of claim 10 wherein said extension extends beyond the transition zone to a point up to 2 inches beyond the point of tangency of said treestand platform.

12. The extension of claim 8 wherein said extension has a width that is from 2-6 inches wider. than the treestand platform to which it is configured to attach, and a length of from 2 to 5 inches, wherein said extension extends beyond the transition zone to a point of from 2 to 6 inches beyond the point of tangency of said treestand platform.

13. A seat extension for enlarging the surface area of a treestand seat, said extension comprising a plurality of openings configured to receive a plurality of fixing bolts for attaching said extension to a treestand seat, said seat having a plurality of receiving holes configured to receive said fixing bolts, said extension generally of rectangular cross section approximating the width of the treestand seat to which it is configured to attach, wherein said extension has a length of from 1 to 6 inches and wherein said extension extends around the outer edge of said seat to a point of up to 6 inches beyond the point of tangency of said seat.

14. A seat extension of claim 13 wherein said extension has a width of from 1 to 6 inches wider than the width of the seat to which it is attached and a length of from 1 to 6 inches, wherein said extension extends 1-4 inches beyond the point of tangency of said seat.

15. A seat extension of claim 14 wherein said extension has a width of from 1 to 4 inches wider than the width of the seat to which it is attached and a length of from 1 to 4 inches, wherein said extension extends to the point of tangency of said seat.
